(19) United States
(12) Patent Application Publication
(10) Pub. No.: US 2014/0014801 A1
(43) Pub. Date: Jan. 16, 2014

(54) ROTATABLE SEAT FOR A SUCKER

(71) Applicant: Lee-Yeh LU, New Taipei City (TW)

(72) Inventor: Lee-Yeh LU, New Taipei City (TW)

(21) Appl. No.: 13/549,144

(22) Filed: Jul. 13, 2012

(51) Int. Cl. F16M 13/00

(52) U.S. Cl. 248/349.1

(57) ABSTRACT

A rotatable seat for a sucker has a stationary plate and a rotating plate. When in used, the stationary plate is attached to the platform of the car by tape or other ways. Because an outside surface of the rotating plate is smooth, the assistant device can be attached to the smooth outside surface easily and securely by sucker. Then the assistant device is connected securely to the platform. Because a mounting segment of the rotating plate is mounted in a mounting hole of the stationary plate, and multiple outside positioning segments on the mounting segment engage with multiple inside positioning segments on the mounting hole, the rotating plate and the stationary plate are relatively rotatable, and are selectively held at specific angles. Thus, the assistant device can be adjusted to a fine visual angle for the user on the passenger seat or the rear seat.

### BACKGROUND OF THE INVENTION

1. Field of the Invention

The present invention relates to a rotatable seat for a sucker, especially to a rotatable seat for a sucker to be attached easily and securely, and then the sucker is rotatable.

2. Description of the Prior Arts

Nowadays, automobile driver usually uses assistant device such as global positioning system (GPS), event data recorder (EDR), television for car or tablet person computer to assist the driving. However, installing the assistant device on the windshield not only affects the sight of the driver, but also is illegal in specific regions or countries. Therefore, the assistant device is usually installed on the platform between the dashboard and the windshield.

The assistant device is usually installed on the platform by a sucker so that the assistant device can be easily detached from the platform when the assistant device is not in use. However, the surface of the platform is curved and uneven so that the sucker is difficult to be attached to the surface of the platform. Besides, even though the sucker can be attached securely to the platform, the sucker and the platform are unable to be rotated relatively. Therefore, the assistant device is unable to be adjusted to a fine visual angle for the user on the passenger seat or the rear seat, which is inconvenient for the user to watch or to operate the assistant device.

To overcome the shortcomings, the present invention provides a rotatable seat for a sucker to mitigate or obviate the aforementioned problems.

### SUMMARY OF THE INVENTION

The main objective of the present invention is to provide a rotatable seat for a sucker to be attached easily and securely, and then the sucker is rotatable.

The rotatable seat for a sucker in accordance with the present invention has a stationary plate and a rotating plate. When the rotatable seat for a sucker is used, the stationary plate is attached to the platform of the car by tape or other ways. Because an outside surface of the rotating plate is smooth, the assistant device can be attached to the smooth outside surface easily and securely by sucker. Then the assistant device is connected securely to the platform, and also can be easily detached when not used. Besides, because a mounting segment of the rotating plate is mounted in a mounting hole of the stationary plate, and multiple outside positioning segments on the mounting segment engage with multiple inside positioning segments on the mounting hole, the rotating plate and the stationary plate are relatively rotatable, and are selectively held at some specific angles. As a result, the assistant device can be adjusted to a fine visual angle for the user on the passenger seat or the rear seat to be watched or operated.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rotatable seat for a sucker in accordance with the present invention;

FIG. 2 is another perspective view of the rotatable seat for a sucker in FIG. 1;

FIG. 3 is an exploded perspective view of the rotatable seat for a sucker in FIG. 1;

FIG. 4 is a top view in partial section of the rotatable seat for a sucker in FIG. 1;

FIG. 5 is a side view in partial section of the rotatable seat for a sucker in FIG. 1; and

FIG. 6 is an operational exploded perspective view of the rotatable seat for a sucker in FIG. 1, showing attaching the assistant device.

### DETAILED DESCRIPTION OF THE PREFERRED EMBODIMENTS

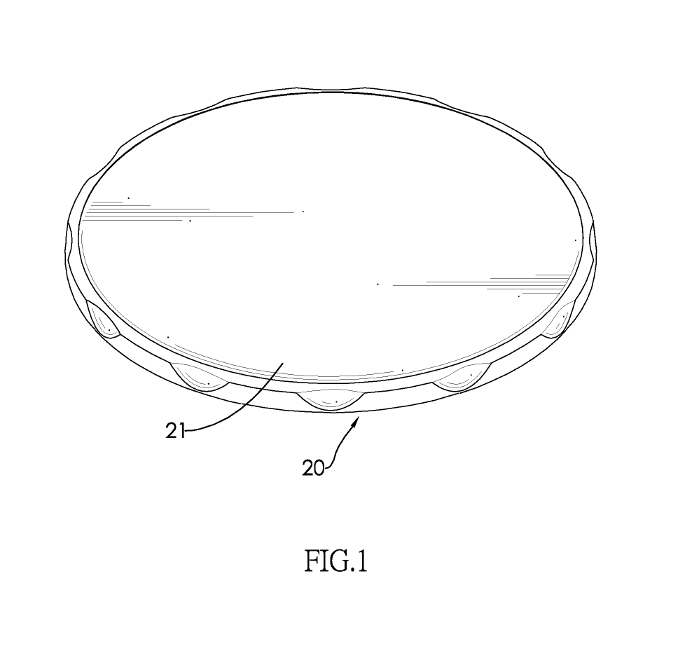

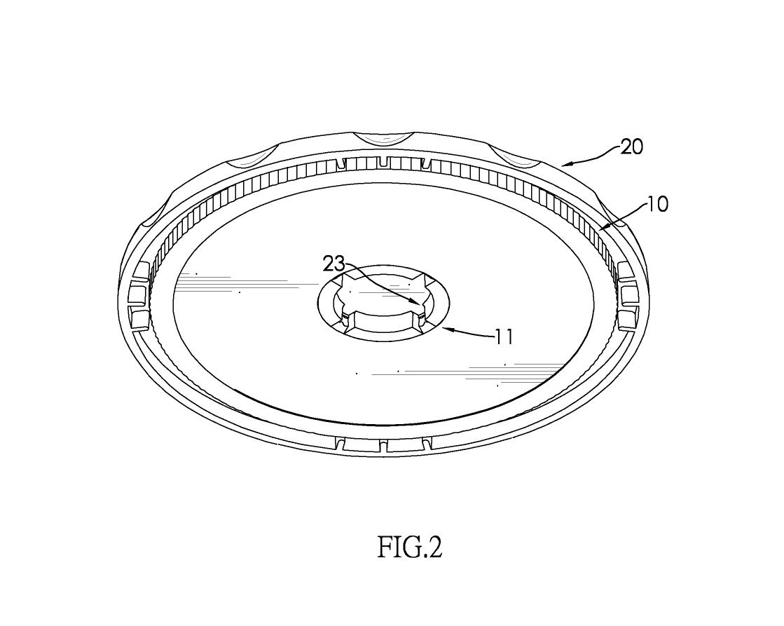

With reference to FIGS. 1 and 2, a rotatable seat for a sucker in accordance with the present invention comprises a stationary plate 10 and a rotating plate 20.

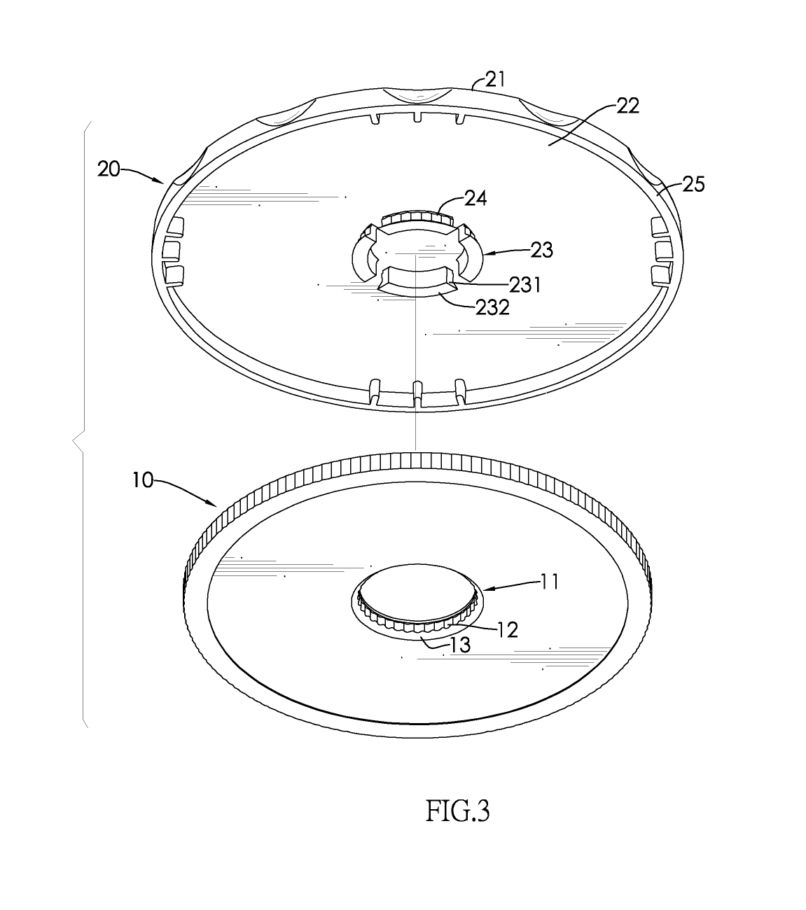

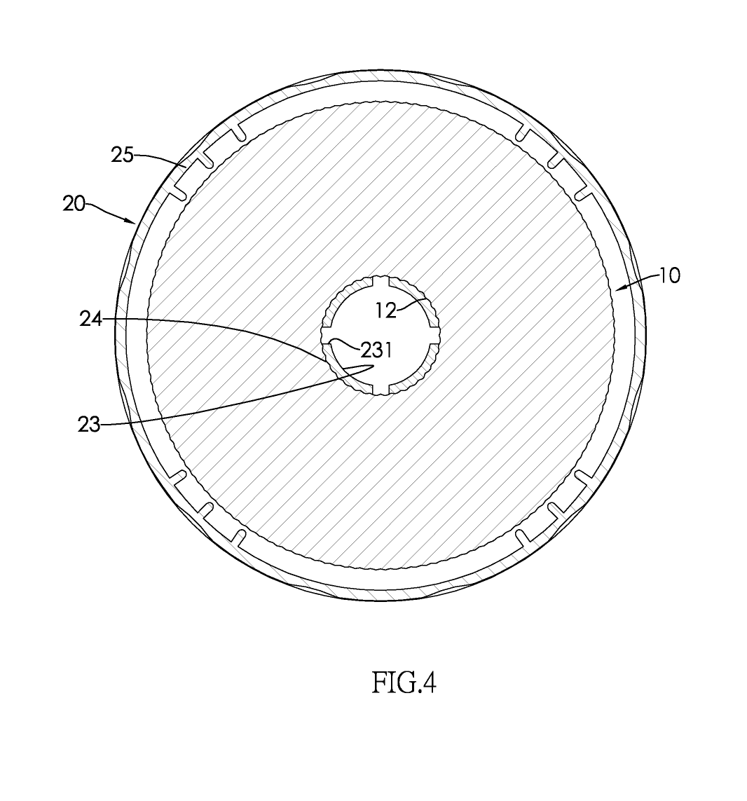

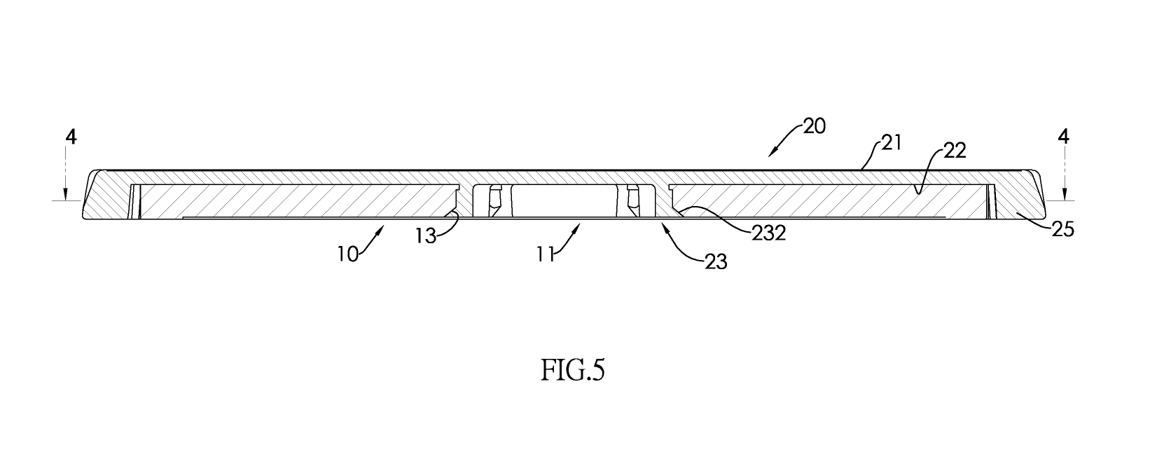

With reference to FIGS. 3 to 5, the stationary plate 10 has a mounting hole 11 and multiple inside positioning segments 12. The mounting hole 11 is circular and is formed through the stationary plate 10. The inside positioning segments 12 are formed separately on an inside wall of the mounting hole 11. In a preferred embodiment, the stationary plate 10 has an annular slope 13. The annular slope 13 is formed around a periphery of the mounting hole 11. Each inside positioning segment 12 is a recess. Moreover, the stationary plate 10 is circular in cross section and is formed integratedly.

The rotating plate 20 is connected pivotally to the stationary plate 10 and has an outside surface 21, an inside surface 22, a mounting segment 23 and multiple outside positioning segments 24. The outside surface 21 is smooth. The mounting segment 23 is circular in cross section, is formed on the inside surface 22 and is mounted in the mounting hole 11 of the stationary plate 10. The outside positioning segments 24 are formed separately on an outside wall of the mounting segment 23 and engage with the inside positioning segments 12 of the stationary plate 10. In a preferred embodiment, each outside positioning segment 24 is a protrusion. Besides, the mounting segment 23 is a hollow sleeve and has multiple gaps 231 formed through the mounting segment 23. The gaps 231 separate the mounting segment 23 into multiple unconnected sections. Moreover, the rotating plate 20 further has a limit flange 232. The limit flange 232 is formed transversely and annularly around an outside wall of the mounting segment 23, is inclined, and abuts and engages the annular slope 13 of the stationary plate 10. Furthermore, the rotating plate 20 is circular in cross section and further has an outside flange 25. The outside flange 25 is formed on the inside surface 22, is formed around a periphery of the rotating plate 20 and surrounds the stationary plate 10. The rotating plate 20 is formed integratedly. A melting point of the stationary plate 10 is higher than a melting point of the rotating plate 20.

When the rotatable seat for a sucker as described is manufactured, the stationary plate 10 with higher melting point is formed by injection molding first. After the stationary plate 10 is cooled down, the rotating plate 20 is formed on the stationary plate 10 by injection molding. Because the melting point of the stationary plate 10 is higher than the melting point of the rotating plate 20, the stationary plate 10 is not melted when the rotating plate 20 is formed by injection molding. Therefore, the rotating plate 20 is not attached securely to the stationary plate 10 after being cooled down.

In addition, the mounting segment 23 of the rotating plate 20 is circular in cross section, and the mounting hole 11 of the stationary plate 10, which is mounted around the mounting segment 23, is circular too. Thus, the stationary plate 10 and the rotating plate 20 are relatively rotatable.

Furthermore, because the inside surface 21 and the limit flange 232 of the mounting segment 23 clamp the stationary plate 10, the stationary plate 10 is unable to move axially relative to the rotating plate 20.

Moreover, with the outside positioning segments 24 on the mounting segment 23 engaging with the inside positioning segments 12 on the mounting hole 11, the stationary plate 10 and the rotating plate 20 are selectively held at some specific angles. Besides, because the gaps 231 separate the mounting segment 23 into multiple unconnected sections, the inside positioning segment 12 presses the outside positioning segment 24 to bend each single section of the mounting segment 23 when the stationary plate 10 and the rotating plate 20 rotate relatively. So that, the stationary plate 10 and the rotating plate 20 can be relatively rotated more smoothly.

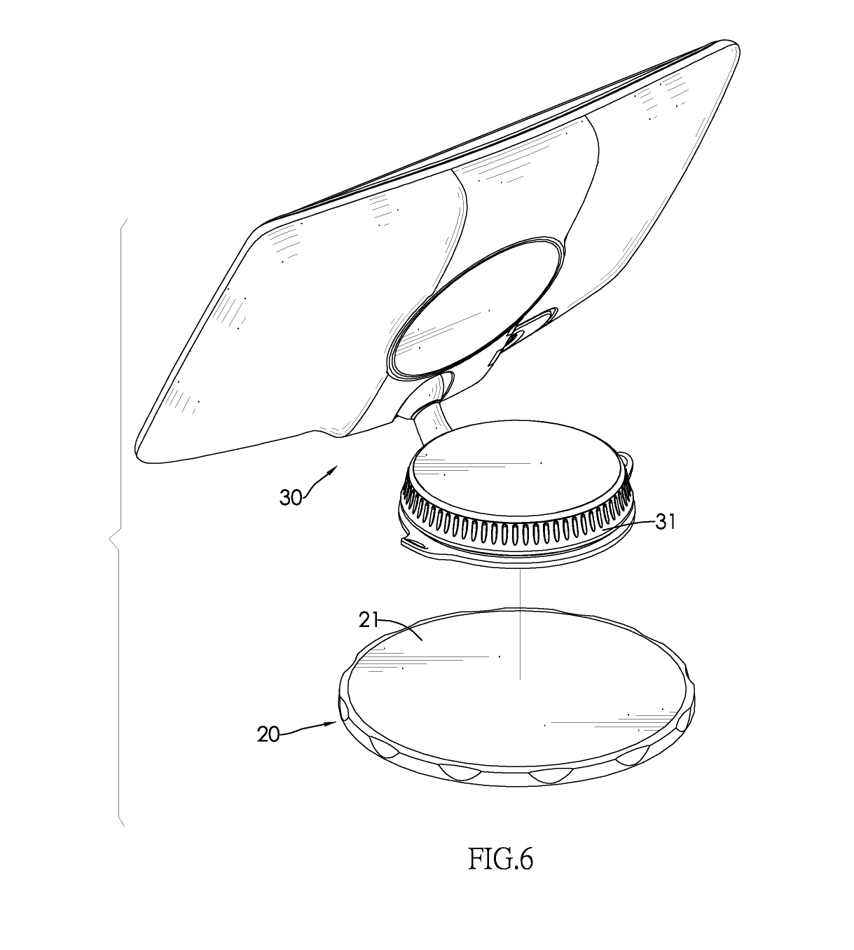

With reference to FIGS. 3 and 6, when the rotatable seat for a sucker as described is in use, the stationary plate 10 is attached to the platform in the car by tape or other ways. Because the outside surface 21 of the rotating plate 20 is smooth, the assistant device 30 such as global positioning system (GPS), event data recorder (EDR), television for car or tablet person computer can be attached to the smooth outside surface 21 easily and securely by a sucker 31. Additionally, the rotating plate 20 and the stationary plate 10 are relatively rotatable, and are selectively held at some specific angles, so that the assistant device 30 can be adjusted to a fine visual angle for the user on the passenger seat or the rear seat to be watched or operated.

In another preferred embodiment, the rotating plate also can have no limit flange, and limits the stationary plate from moving axially relative to the rotating plate by other ways.

In another preferred embodiment, including used in cars, the rotatable seat for a sucker as described also can be used in other places, where need to be attached by sucker and need to be rotatable relatively to the sucker.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rotatable seat for a sucker comprising:
a stationary plate having
a mounting hole formed through the stationary plate, and being circular; and
multiple inside positioning segments formed separately on an inside wall of the mounting hole; and
a rotating plate connected pivotally to the stationary plate, and having
an outside surface being smooth;
an inside surface;
a mounting segment formed on the inside surface, being circular in cross section, and mounted in the mounting hole of the stationary plate; and
multiple outside positioning segments formed separately on an outside wall of the mounting segment, and engaging with the inside positioning segments of the stationary plate.

2. The rotatable seat for a sucker as claimed in claim 1, wherein
the stationary plate is formed integratedly;
the rotating plate is formed integratedly; and
a melting point of the stationary plate is higher than a melting point of the rotating plate.

3. The rotatable seat for a sucker as claimed in claim 2, wherein the rotating plate has
a limit flange formed transversely and annularly around the outside wall of the mounting segment of the rotating plate, and abutting a periphery of the mounting hole of the stationary plate.

4. The rotatable seat for a sucker as claimed in claim 3, wherein
the stationary plate has an annular slope formed around the periphery of the mounting hole; and
the limit flange of the rotating plate is inclined, and engages the annular slope of the stationary plate.

5. The rotatable seat for a sucker as claimed in claim 1, wherein the mounting segment of the rotating plate is a hollow sleeve, and has multiple gaps formed through the mounting segment.

6. The rotatable seat for a sucker as claimed in claim 4, wherein the mounting segment of the rotating plate is a hollow sleeve, and has multiple gaps formed through the mounting segment.

7. The rotatable seat for a sucker as claimed in claim 1, wherein
each inside positioning segment of the stationary plate is a recess; and
each outside positioning segment of the rotating plate is a protrusion.

8. The rotatable seat for a sucker as claimed in claim 6, wherein
each inside positioning segment of the stationary plate is a recess; and
each outside positioning segment of the rotating plate is a protrusion.

9. The rotatable seat for a sucker as claimed in claim 1, wherein
the stationary plate is circular in cross section; and
the rotating plate is circular in cross section, and has
an outside flange formed on the inside surface of the rotating plate, formed around a periphery of the rotating plate, and surrounding the stationary plate.

10. The rotatable seat for a sucker as claimed in claim 8, wherein
the stationary plate is circular in cross section; and
the rotating plate is circular in cross section, and has
an outside flange formed on the inside surface of the rotating plate, formed around a periphery of the rotating plate, and surrounding the stationary plate.
